(19) United States
(12) Patent Application Publication
(10) Pub. No.: US 2023/0021390 A1
(43) Pub. Date: Jan. 26, 2023

(54) Heated Hand Grip

(71) Applicant: John Lyles, Cherry Hill, NJ (US)

(72) Inventor: John Lyles, Cherry Hill, NJ (US)

(21) Appl. No.: 17/869,626

(22) Filed: Jul. 20, 2022

Related U.S. Application Data
(63) Continuation-in-part of application No. 29/805,565, filed on Aug. 27, 2021.
(60) Provisional application No. 63/223,857, filed on Jul. 20, 2021.

(51) Int. Cl. H05B 3/36

(52) U.S. Cl. CPC H05B 3/36; F41B 5/148

(57) ABSTRACT

A heated hand grip that is adhered onto the grip section of the bow or the handle section of the fishing rod includes a flexible substrate, a malleable heating element, and a power port. The flexible substrate includes a conductive layer and an insulating layer, wherein the conductive layer is superimposed onto the insulating layer. The malleable heating element is integrated in between the conductive layer and the insulating layer. The power port is externally connected onto the flexible substrate as the malleable heating element is electrically connected to the power port. When the malleable heating element is powered through the power port, the malleable heating element is able to provide warmth to the conductive layer which in return warms the exposed hands of the bow hunters and anglers.

The current application claims a priority to the U.S. Provisional Patent application Ser. No. 63/223,857 filed on Jul. 20, 2021.

The current application is also a continuation-in-part (CIP) application of the U.S. design application Ser. No. 29/805,565 filed on Aug. 27, 2021.

### FIELD OF THE INVENTION

The present invention relates generally to outdoor sport accessories. More specifically, the present invention is a heated hand grip to be used with outdoor sport equipment such as bows and fishing poles.

### BACKGROUND OF THE INVENTION

In a world full of different hobbies and interests, many people enjoy spending time in the outdoors. Hunting and fishing are two of the most popular pastimes of people that enjoy outdoor sports. Sports like hunting and fishing require particular equipment for each in order for one to truly partake in these sports. Hunters typically have a wider selection of equipment than anglers (those who fish with a hook and a line), having the choice of a variety of firearms or an assortment of bows. Bowhunting is a type of hunting that utilizes archery to hunt game rather than firearms. While hunting has designated seasons for individuals to partake in, typically in warmer months, others may enjoy practicing outdoors during the offseason. Additionally, many anglers may normally fish during warmer months, but those in colder climates may find it difficult to do so. The colder weather can be harsh on the exposed hands of bow hunters or anglers as they grip their respective equipment.

An objective of the present invention is to provide bow hunters and anglers with a way to make bow hunting and fishing more comfortable while out in lower ambient temperatures. The present invention is an apparatus that one can place around the grasping arear of either a bow or a fishing rod. The present invention includes a flexible heating element that can sit between the corresponding equipment and the hand of the user. The present invention includes an internal heating components powered by an external battery. The warmth provided by the internal heating components warms the exposed hands of bow hunters and anglers, making these activities more enjoyable in colder temperatures.

### BRIEF DESCRIPTION OF THE DRAWINGS

FIG. 1 is a top perspective view of the present invention, wherein the flexible substrate is shaped to attach around the grip section of the bow.

FIG. 2 is a bottom perspective view of the present invention, wherein the flexible substrate is shaped to attach around the grip section of the bow.

FIG. 3 is a top view of the present invention, wherein the flexible substrate is shaped to attach around the grip section of the bow.

FIG. 4 is a basic schematic diagram showing the electrical connections of the present invention.

FIG. 5 is a basic schematic diagram showing the configuration for the flexible substrate, the heat-conductive layer, and the adhesive layer of the present invention.

FIG. 6 is a top view of the present invention, wherein the flexible substrate is shaped to attach around the handle section of the fishing rod.

### DETAIL DESCRIPTIONS OF THE INVENTION

All illustrations of the drawings are for the purpose of describing selected versions of the present invention and are not intended to limit the scope of the present invention.

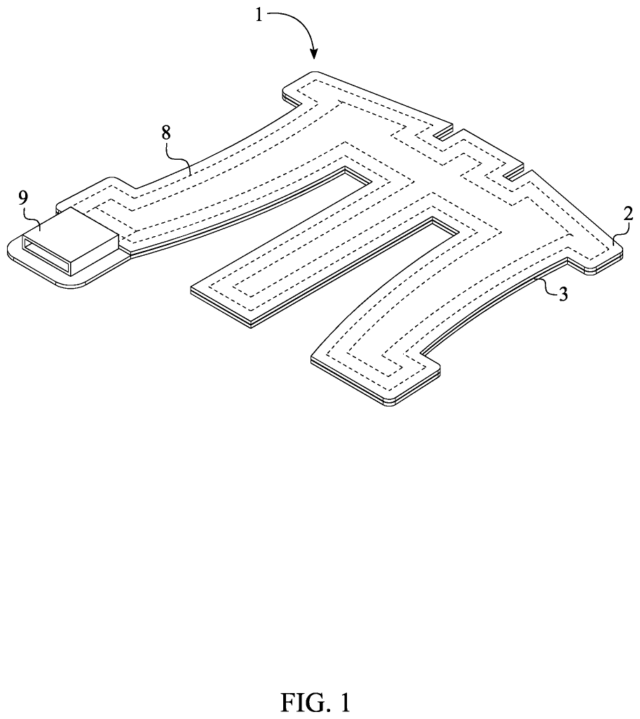

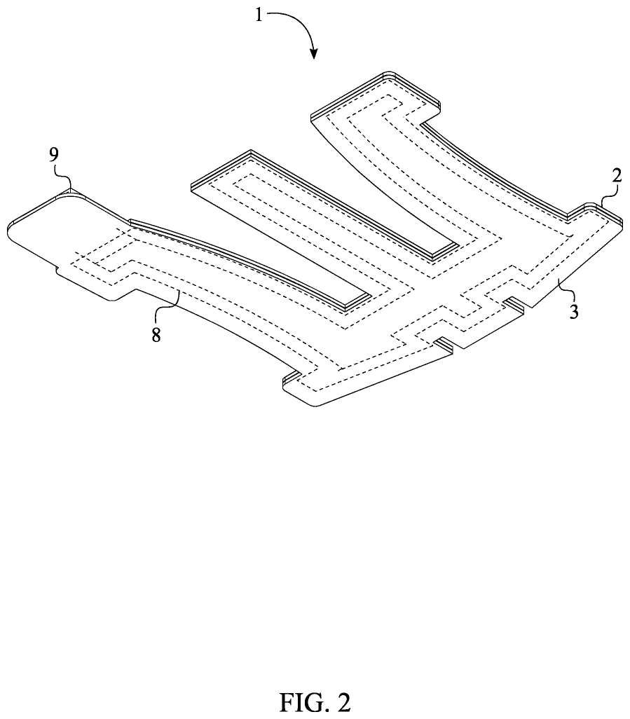

The present invention is a heated hand grip that can preferably attach to a bow or a fishing rod. The present invention attempts to provide anglers and bow hunters with a more enjoyable experience when hunting and fishing in lower ambient temperatures by keeping their exposed hand warm. More specifically, the present invention attaches to a grip section of the bow and a handle section of the fishing rod to provide warmth to user's hands. As shown in FIG. 1 and FIG. 2, the present invention comprises a flexible substrate 1, a malleable heating element 8, and a power port 9.

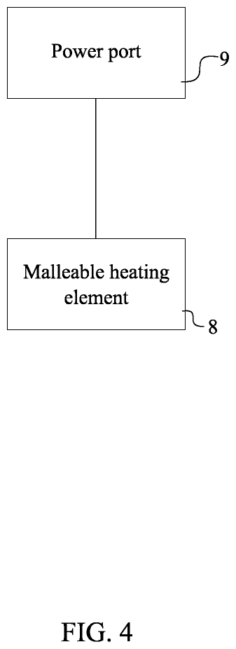

In reference to the general configuration of the present invention, as shown in FIGS. 1-4, the flexible substrate 1 provides the general shape of the present invention and comprising a conductive layer 2 and an insulating layer 3. The conductive layer 2 is superimposed onto the insulating layer 3. The conductive layer 2 functions as the heat transferring layer, and the insulating layer 3 functions as the thermal insulating layer 3. The malleable heating element 8 is integrated in between the conductive layer 2 and the insulating layer 3 so that the flexible substrate 1 can be heated. The power port 9 is externally connected onto the flexible substrate 1 so that the user can easily access the power port 9. The malleable heating element 8 is electrically connected to the power port 9 so that the power port 9 can provide an electrical current to power the malleable heating element 8.

In reference to FIGS. 1-3 and FIG. 5, the conductive layer 2 is oriented outward from the bow or the fishing rod and positioned adjacent to user's hands when installed to the corresponding equipment. As a result, thermal energy from the malleable heating element 8 can be transferred into the conductive layer 2 through thermal conduction. The insulating layer 3 is positioned towards the surface area of the bow or the fishing rod to prevent heat transferring. As a result, the insulating layer 3 is able protect the corresponding equipment from unwanted damage that may occur due to thermal energy. In order to maximize the functionality of the flexible substrate 1, the conductive layer 2 and the insulating layer 3 are coextensively positioned with each other.

In reference to FIGS. 1-3, the malleable heating element 8 converts an electrical energy, preferably a direct current flow, into thermal energy. The malleable heating element 8 is evenly spaced within the flexible substrate 1 so that the flexible substate can be uniformly heated without any random cold spots. Furthermore, the malleable heating element 8 is able to bend and flex according to the contours of the bow or the fishing rod without compromising the functionality.

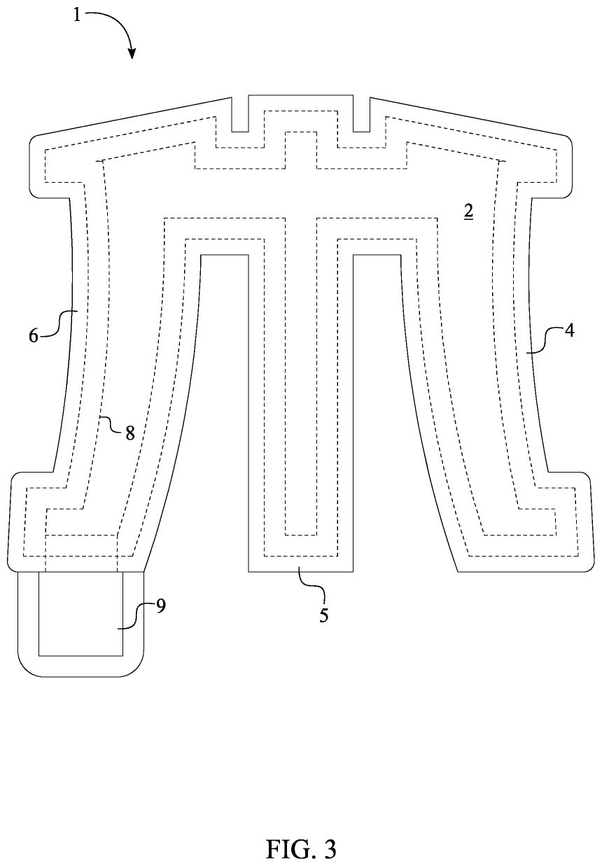

In reference to FIG. 3, the power port 9 is externally positioned to the flexible substrate 1 so that the user can easily access the power port 9 to plug in an external power source. Even though an industry standard power port 9 is utilized within the present invention, the shape and type of the power port 9 can differ based on the external power source. For examples, I-type battery clip is utilized as the power port 9 when the malleable heating element 8 is powered from a 9-volt battery. A Universal Serial Bus (USB) power clip is utilized as the power port 9 when the malleable heating element 8 is powered from a rechargeable battery pack with a USB power connection.

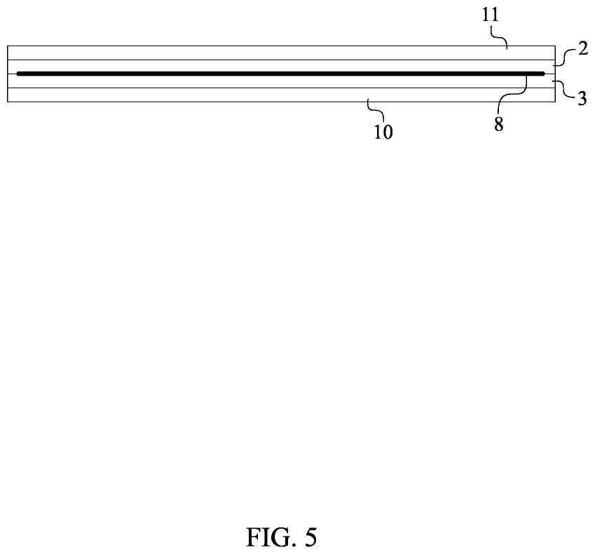

In reference to FIG. 5, the present invention further comprises a heat-conductive layer 11 to protect the flexible substrate 1 from outside elements such as dirt and water. More specifically, the heat-conductive layer 11 and the insulating layer 3 are oppositely positioned of each other about the conductive layer 2 so that the conductive layer 2 can be externally protected. In a preferred embodiment of the present invention, the heat-conductive layer 11 is superimposed onto the conductive layer 2 and coextensively positioned to the conductive layer 2. In other words, the heat-conductive layer 11 is integrated into the flexible substrate 1. Even though the heat-conductive layer 11 is superimposed onto the conductive layer 2 of the preferred embodiment of the present invention, the present invention can also be completed without the heat-conductive layer 11 in an alternative embodiment. If the user prefers to protect the flexible substrate 1 from outside elements, the user can use any industry standard heat conductive films, wraps, or tapes to fully cover the flexible substrate 1 as the heat-conductive layer 11 is removably mounted to the conductive layer 2.

In reference to FIG. 5, the present invention further comprises an adhesive layer 10 to so that the flexible substrate 1 can be easily attached to the bow or the fishing rod. More specifically, the adhesive layer 10 is superimposed onto the insulating layer 3 and coextensively positioned to the insulating layer 3. In other words, the adhesive layer 10 and the conductive layer 2 are oppositely positioned of each other about the insulating layer 3.

In reference to FIG. 3, the flexible substrate 1 comprises a left section 4, a middle section 5, and a right section 6 when the present invention is shaped to attach around the grip section of the bow. More specifically, the left section 4 and the right section 6 are oppositely positioned of each other about the middle section 5. The left section 4 is adjacently connected to the middle section 5. The right section 6 is adjacently connected to the middle section 5. The malleable heating element 8 is integrated into the left section 4, the middle section 5, and the right section 6 so that flexible substrate 1 can be evenly heated. The adhesive layer 10 is adhered onto the grip section of the bow in such a way that the middle section 5 is adhered to the front wall of the grip section, the left section 4 is adhered to the left wall of the grip section, and the right section 6 is adhered to the right wall of the grip section.

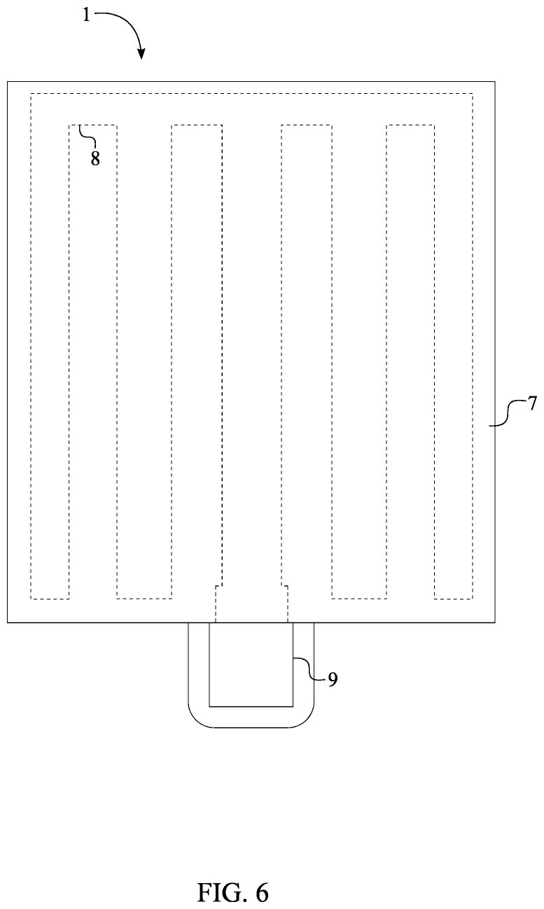

In reference to FIG. 6, the flexible substrate 1 comprises a rectangular section 7 when the present invention is shaped to attach around the handle section of the fishing rod. More specifically, the rectangular section 7 is adhered around the handle section of the fishing rod as the adhesive layer 10 is adhered onto the handle section of the fishing rod. The malleable heating element 8 is integrated into the rectangular section 7 so that the flexible substrate 1 can be evenly heated.

Once the present invention is installed to the bow or the fishing rod, the user can place their hand around the heat conductive layer 2 so that one's fingers are resting on the present invention. To provide warmth to the angler or bow hunter's hand, one must simply attach the external power source into the power port 9 thus activating the malleable heating element 8 within the flexible substrate 1. The thermal energy then spreads through the flexible substrate 1 and transfers into the user's hand via the conductive layer 2 and the heat-conductive layer 11.

Although the invention has been explained in relation to its preferred embodiment, it is to be understood that many other possible modifications and variations can be made without departing from the spirit and scope of the invention as hereinafter claimed.

What is claimed is:

1. A heated hand grip comprising:
a flexible substrate;
a malleable heating element;
a power port;
the flexible substrate comprising a conductive layer and an insulating layer;
the conductive layer being superimposed onto the insulating layer;
the malleable heating element being integrated in between the conductive layer and the insulating layer;
the power port being externally connected onto the flexible substrate; and
the malleable heating element being electrically connected to the power port.

2. The heated hand grip as claimed in claim 1 comprising:
a heat-conductive layer; and
the heat-conductive layer and the insulating layer being oppositely positioned of each other about the conductive layer.

3. The heated hand grip as claimed in claim 2, wherein the heat-conductive layer is superimposed onto the conductive layer.

4. The heated hand grip as claimed in claim 2, wherein the heat-conductive layer is removed mounted to the conductive layer.

5. The heated hand grip as claimed in claim 1 comprising:
an adhesive layer;
the adhesive layer being superimposed onto the insulating layer; and
the adhesive layer and the conductive layer being oppositely positioned of each other about the insulating layer.

6. The heated hand grip as claimed in claim 5 comprising:
the flexible substrate comprising a left section, a middle section, and a right section;
the left section and the right section being oppositely positioned of each other about the middle section;
the left section being adjacently connected to the middle section;
the right section being adjacently connected to the middle section; and
the malleable heating element being integrated into the left section, the middle section, and the right section, wherein the adhesive layer is adhered onto a grip section of the bow.

7. The heated hand grip as claimed in claim 5 comprising:
the flexible substrate comprising a rectangular section; and
the malleable heating element being integrated into the rectangular section, wherein the adhesive layer is adhered onto a handle section of the fishing rod.

8. A heated hand grip comprising:
a flexible substrate;
a malleable heating element;
a power port;
a heat-conductive layer;
the flexible substrate comprising a conductive layer and an insulating layer;
the conductive layer being superimposed onto the insulating layer;
the heat-conductive layer and the insulating layer being oppositely positioned of each other about the conductive layer.
the malleable heating element being integrated in between the conductive layer and the insulating layer;
the power port being externally connected onto the flexible substrate; and
the malleable heating element being electrically connected to the power port.

9. The heated hand grip as claimed in claim 8, wherein the heat-conductive layer is superimposed onto the conductive layer.

10. The heated hand grip as claimed in claim 8, wherein the heat-conductive layer is removed mounted to the conductive layer.

11. The heated hand grip as claimed in claim 8 comprising:
an adhesive layer;
the adhesive layer being superimposed onto the insulating layer; and
the adhesive layer and the conductive layer being oppositely positioned of each other about the insulating layer.

12. The heated hand grip as claimed in claim 11 comprising:
the flexible substrate comprising a left section, a middle section, and a right section;
the left section and the right section being oppositely positioned of each other about the middle section;
the left section being adjacently connected to the middle section;
the right section being adjacently connected to the middle section; and
the malleable heating element being integrated into the left section, the middle section, and the right section, wherein the adhesive layer is adhered onto a grip section of the bow.

13. The heated hand grip as claimed in claim 11 comprising:
the flexible substrate comprising a rectangular section; and
the malleable heating element being integrated into the rectangular section, wherein the adhesive layer is adhered onto a handle section of the fishing rod.

14. A heated hand grip comprising:
a flexible substrate;
a malleable heating element;
a power port;
a heat-conductive layer;
an adhesive layer;
the flexible substrate comprising a conductive layer and an insulating layer;
the conductive layer being superimposed onto the insulating layer;
the heat-conductive layer and the insulating layer being oppositely positioned of each other about the conductive layer.
the adhesive layer being superimposed onto the insulating layer;
the adhesive layer and the conductive layer being oppositely positioned of each other about the insulating layer;
the malleable heating element being integrated in between the conductive layer and the insulating layer;
the power port being externally connected onto the flexible substrate; and
the malleable heating element being electrically connected to the power port.

15. The heated hand grip as claimed in claim 14, wherein the heat-conductive layer is superimposed onto the conductive layer.

16. The heated hand grip as claimed in claim 14, wherein the heat-conductive layer is removed mounted to the conductive layer.

17. The heated hand grip as claimed in claim 14 comprising:
the flexible substrate comprising a left section, a middle section, and a right section;
the left section and the right section being oppositely positioned of each other about the middle section;
the left section being adjacently connected to the middle section;
the right section being adjacently connected to the middle section; and
the malleable heating element being integrated into the left section, the middle section, and the right section, wherein the adhesive layer is adhered onto a grip section of the bow.

18. The heated hand grip as claimed in claim 14 comprising:
the flexible substrate comprising a rectangular section; and
the malleable heating element being integrated into the rectangular section, wherein the adhesive layer is adhered onto a handle section of the fishing rod.
